(19) United States
(12) Patent Application Publication
(10) Pub. No.: US 2006/0011142 A1
(43) Pub. Date: Jan. 19, 2006

(54) Hanging pet water feeder apparatus for vehicles, boats, and walls

(76) Inventor: Michael Walter, Absecon, NJ (US)

Correspondence Address: JOHNSON & STAINBROOK, LLP, 3558 ROUND BARN BLVD., SUITE 203, SANTA ROSA, CA, 95403, US

(21) Appl. No.: 11/182,919

(22) Filed: Jul. 14, 2005

Related U.S. Application Data
(60) Provisional application No. 60/587,814, filed on Jul. 14, 2004.

(51) Int. Cl. A01K 7/00

(52) U.S. Cl. 119/72.5

(57) ABSTRACT

A pet water feeder for installation on window in vehicles and on boats, including a housing base and a housing cover, hingedly connected and capable of forming an enclosure. Means of retaining a pet water feeding fluid container with drinking tubes are disposed within the enclosure, such that the drinking tubes extend from the bottom portion of the housing cover when the housing is closed. Thermally insulative material is provided on the interior surfaces of the base and cover.

### CROSS REFERENCE TO RELATED APPLICATIONS

The present application claims the benefit of the filing date of U.S. Provisional Patent Application Ser. No. 60/587,814, filed Jul. 14, 2004.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to pet feeding and watering devices, and more particularly to a pet water feeder adapted for installation on the interior side of a vehicle window.

### BACKGROUND INFORMATION AND DISCUSSION OF RELATED ART

Dogs routinely travel with their owners or handlers. While inside a traveling vehicle, dogs typically do not have too much difficulty maintaining proper body temperature and hydration: a caring owner will note behavior indicative of the need for water and will attend to that need. However, on long trips, maintaining proper pet hydration can be difficult. Additionally, dogs are not always permitted to accompany the owner or handler when it is necessary for the owner/handler to leave the vehicle for business, errands, or social visits. This gives rise to the need to ensure that the animal is properly cooled and hydrated both on long trips and during an owner's absence while a vehicle is parked.

Several pet watering devices have been employed to provide hydration to caged or confined pets, such as hamsters, mice, and dogs. Typically the bottle comprises nothing more than a water container having a cap and roller ball tube depending downwardly from the container, so that the animal can lick the roller ball and thereby obtain hydration.

Numerous patents show a variety of pet water feeding apparatus. Exemplary designs include U.S. Pat. No. 5,488,927, to Lorenzana, et al, which teaches an animal food dish and water dispenser combination that includes first and second cup-shaped receptacles spaced apart in a base member having an upwardly projecting barrier separating the two receptacles and supporting an inverted water reservoir bottle centrally on the base member to supply water to one of the receptacles.

U.S. Pat. No. D384,779, to Krause, shows a conventional water bottle feeder of the kind described above, with an ornamental wedge-shaped bottle.

U.S. Pat. No. 5,549,074, to Hui, shows a water drinking device for pets including a water container with a cap having a ventilation hole. The container has a slanted bottom such that the water outlet is higher than the bottom end of the container and that the water flowing from the water outlet is free from impurities. The container has a plurality of locating slots with a locating recess engageable with a retaining arm of a container hanger.

U.S. Pat. No. 5,363,802, to Huff, teaches a gnaw proof water dispenser for attachment to an animal cage, including a bottle with a drinking tube and a resilient hanger for installing he bottle in an animal cage.

U.S. Pat. No. 5,245,951, to Nicholson, discloses a cool water dispenser for animals which includes an insulated container having a dispensing nozzle mounted to the lower end thereof and which includes an intermediate porous baffle for supporting cubes of ice so the ice will not block or interfere with the dispensing nozzle.

The foregoing patents and the above-described devices reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### BRIEF SUMMARY OF THE INVENTION

The present invention is a pet watering feeder apparatus adapted for installation on the interior of an automobile, truck, boat, or other vehicle window for use in keeping pets suitably hydrated when traveling or when away from the vehicle. The portable watering apparatus may also be installed on a wall having a suitable hanging bracket.

It is therefore an object of the present invention to provide a new and improved pet watering apparatus for use in vehicles.

It is another object of the present invention to provide a new and improved portable pet water feeder that provides thermal insulation to drinking material.

A further object or feature of the present invention is a new and improved pet water feeder in which fluid container are housed in an aesthetically pleasing cover.

An even further object of the present invention is to provide a novel pet water feeder that securely holds the fluid container and fluid outlet tubes while an animal is drinking.

Other novel features which are characteristic of the invention, as to organization and, method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty that characterize the invention are pointed out with particularity in the claims annexed to and forming part of this disclosure. The invention does not reside in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a perspective view showing the inventive pet water feeder installed on a vehicle window;

FIG. 2 is a perspective view showing the inventive apparatus with its housing cover open and the water bottle clipped onto its housing base;

FIG. 3 is a cross-sectional side view in elevation showing the apparatus of FIGS. 1-2 with the cover closed; and

FIG. 4 is a bottom view showing the housing base and the installation hardware

### DETAILED DESCRIPTION OF THE INVENTION

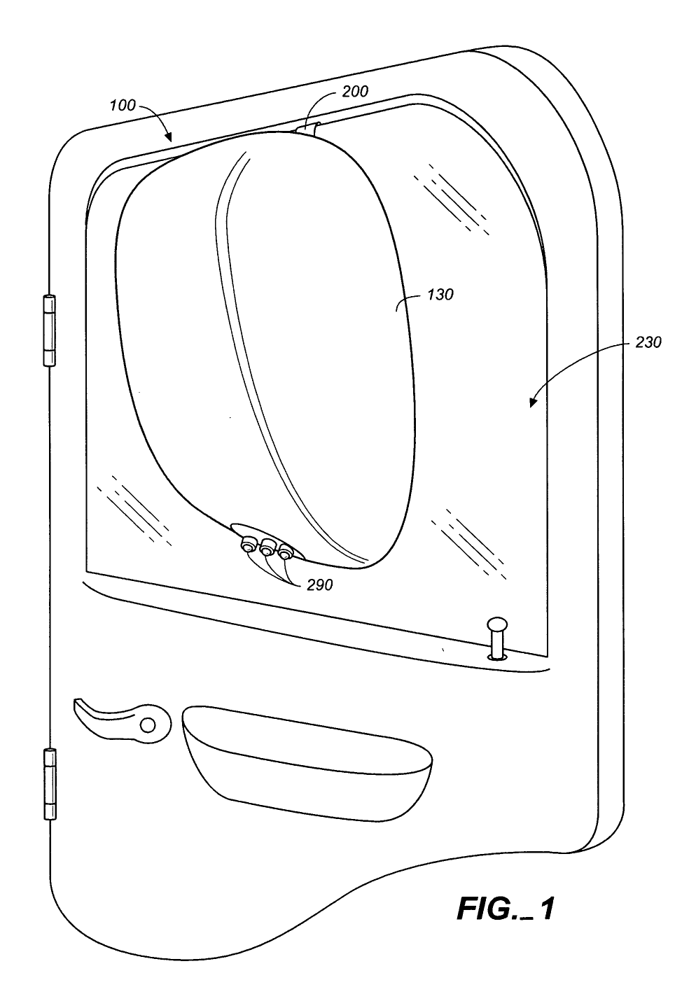

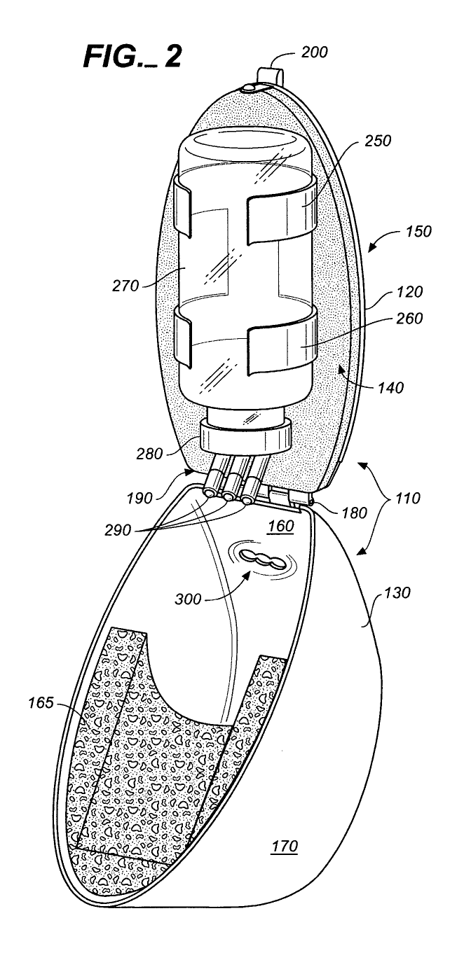

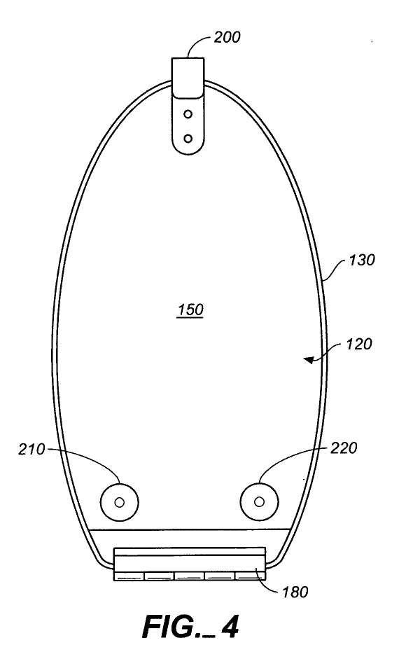

Referring to FIGS. 1 through 4, wherein like reference numerals refer to like components in the various views, there is illustrated therein a new and improved pet water feeder, generally denominated 100 herein.

FIGS. 1 through 4 illustrate the best mode of carrying out the invention and collectively show that the inventive apparatus comprises a housing 110, including a generally planar housing base 120 and a housing cover 130, the former including an interior side 140 and an exterior side 150, and the latter including an interior surface 160 and an exterior surface 170. The base and housing are coupled with a hinge 180 proximate the bottom edge 190 of the housing base. The housing base and housing cover may be coupled or otherwise secured together to form a closed configuration by a coupling device, which may be any of a number of suitable kinds, including a tab disposed outwardly from the upper portion of the housing base and having a nipple 310 insertable in a hole at the upper portion of the cover. When the base and cover are coupled together, an interior space is formed which is suitable for containing a bottle or other type of fluid container.

As an alternative to a hinged connection, the base and housing cover could be connected with clips, snap locks, a tab and slot configuration, and so forth, in which event the housing cover could be entirely removed from the housing base.

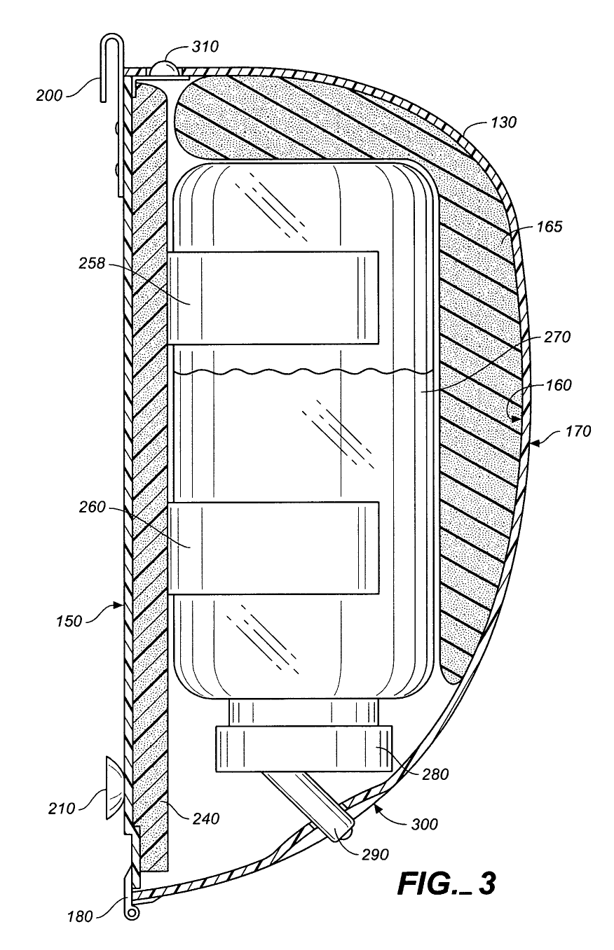

The exterior side 150 of the housing base includes attachment means, preferably at least one clip 200 and one or more suction cups 210, 220, which allow the housing to be installed and secured on the interior side of a vehicle window or boat window 230. It will be readily appreciated that the housing could be installed on a complementary bracket installed on a wall in any kind of structure. In place of clip 200, yet another suction cup or other attachment means could be employed to enable attachment to other portions of vertical surfaces. In the first preferred embodiment illustrated, the housing cover has a generally arcuate cross-sectional profile (FIG. 3). However, it may be shaped to more closely conform to the shape of the water bottle to be installed, in which event the retention clips may be disposed on the interior surface of the housing cover.

The interior side 140 of the housing base may be provided with insulating foam or freezer ice pack material 240, and the interior surface 160 of the housing cover may also be provided with insulating foam or freezer ice pack material 165. Accordingly, when installed on a window in hot weather, freezer pack material will keep water cold; and when installed on a window in extremely cold whether, the insulative material will keep the bottle from freezing.

The housing is further provided with retention means, preferably one or more resilient arcuate clips 250, 260, adapted for holding a generally cylindrical water bottle or a liquid bladder 270. Straps having hook and loop fastener material at the ends would be a suitable alternative to clips.

The bottle includes a cap 280 having at least one, and preferably a plurality, of roller ball water drinking tubes 290 which insert through at least one drinking tube hole 300 (preferably several) disposed in the lower portion of the housing cover, the drinking tube holes generally corresponding to the number and arrangement of the drinking tubes. The sizing and shape of the holes are ideally closely matched to the size of the drinking tubes to that the holes assist the retention clips in holding the bottle securely while an animal drinks.

As will be readily appreciated, the bottle may be removed for filling and for use outside the vehicle; when taking the pet to a park, for instance.

According to the foregoing description, it will be seen that when the bottle or bladder is filled with water and the housing installed on a vehicle window or boat window or wall, as described above, a pet will have access to water when and as needed.

To prevent condensation from collecting and dripping from the feeding tubes when cooled liquids are provided, an absorbent pad (not shown) may be positioned immediately under the feeding tubes and above the hinge.

It will be also appreciated by those with skill in the art that nutrients other than liquids could be provided and delivered by a bottle having slightly enlarged feeding tubes. Additionally, when liquids are provided in the bottle or bladder, food may be stored in the housing for selective feeding of the pet.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A pet water feeder, comprising:
a substantially planar housing base having an interior surface, an exterior surface; a bottom edge, and an upper portion;
a housing cover attached to said housing base with a hinge, said housing cover having an interior surface and an exterior surface, a lower portion and an upper portion, and at least one drinking tube hole disposed in said lower portion, said housing cover coupled to said housing base by a hinge proximate said bottom edge of said housing base;
coupling means for coupling said upper portion of said housing cover to said upper portion of said housing base to form an interior space;
a fluid container having at least one drinking tube; and
retention means for securing said fluid container within the interior space such that said drinking tube is disposed through the drinking tube hole in said lower portion of said housing cover when said housing cover coupled to said housing base.

2. The apparatus of claim 1, further including insulation material disposed on said interior surface of said housing base and on said interior surface of said housing cover.

3. The apparatus of claim 1, wherein said fluid container includes a plurality of drinking tubes.

4. The apparatus of claim 1, wherein said retention means comprises at least one resilient arcuate clip.

5. The apparatus of claim 1, further including at least one suction cup disposed on said exterior surface of said housing base.
